(19) United States
(12) Patent Application Publication
(10) Pub. No.: US 2016/0227776 A1
(43) Pub. Date: Aug. 11, 2016

(54) COMPOSITION CONTAINING ATTRACTANT OF NOXIOUS ARTHROPOD COMPRISING PLANT-DERIVED COMPONENT AND ANALOGUE OF SAME

(71) Applicant: KYOYU AGRI CO., LTD., Kanagawa (JP)

(72) Inventors: Kei KAWAZU, Nagano (JP); Eiko YAMAMOTO, Miyagi (JP)

(73) Assignee: KYOYU AGRI CO., LTD., Kanagawa (JP)

(21) Appl. No.: 15/022,224

(22) PCT Filed: Oct. 1, 2014
(86) PCT No.: PCT/JP2014/076287

§ 371 Date: Mar. 16, 2016

(30) Foreign Application Priority Data
Oct. 2, 2013 (JP) 2013-207440

(51) Int. Cl. A01N 43/40; A01N 31/02; A01N 35/02; A01N 37/10; A01N 33/10; A01N 35/04; A01N 37/44

(52) U.S. Cl. CPC A01N 43/40; A01N 35/04; A01N 31/02; A01N 37/44; A01N 37/10; A01N 33/10; A01N 35/02

(57) ABSTRACT

This invention provides a composition with method of controlling and attracting noxious arthropods, and protecting plants from damage caused by noxious arthropods. The invention provides a noxious arthropod attractant composition that shows synergistic effects and comprises at least two types of compounds selected from the group consisting of p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde.

### TECHNICAL FIELD

This invention relates to a composition for attracting noxious arthropods, a method for controlling the behavior of noxious arthropod populations through the attraction, and particularly, a method for controlling and forecasting plant damage caused by noxious arthropods.

### BACKGROUND ART

Damage to cultivated crops by noxious arthropods is becoming a global problem. There are some noxious arthropods that transmit viruses and cause serious damage to crops by inducing viral diseases therein. However, in the case of microscopic noxious arthropods that thrive in closed locations such as buds, detection at low densities and control using agricultural chemicals are difficult. Moreover, reduced control effects due to the appearance of resistance to insecticides and effects on the environment attributable to the use of insecticides are coming to be viewed as problems. Thus, in order to reduce damage to cultivated crops and plants, there is a need for a method for detecting noxious arthropod populations and suppressing the noxious arthropod population density.

Noxious arthropods utilize volatile chemicals produced and released by plants in order to use host plants. Several plant-derived compounds act as attractants of noxious arthropods, and noxious arthropods can be attracted by using a suitable trap with attractant (Patent Document 1; Patent Document 2; Non Patent Document 1; Non Patent Document 2).

A kairomone is defined as a chemical produced by a certain species of organism that is disadvantageous to the species that produces it but has an advantageous effect on another species that receives it. In addition, chemicals produced by plants that attract an herbivore that receives it are also kairomones, and these chemicals are referred to as plant-derived kairomones. Although there are numerous chemicals that have been found to be attractant compounds, aromatic compounds are known to be plant-derived kairomones. Numerous plant kairomones have been reported to be attractants of various types of noxious arthropods. For example, leaf alcohol, esters thereof, methyl isoeugenol and analogue compounds thereof have been clearly determined to be kairomones that attract male and female adult Anomala cuprea (Patent Document 1; Patent Document 2), and traps using these chemicals as attractants are used in monitoring tool (method). In addition, a flower aromatic in the form of benzyl acetate and six derivative components thereof have been clearly determined to attract Cryptomeria twing (Patent Document 3; Patent Document 4; Patent Document 5), and traps using these chemicals as attractants are already being used in monitoring tool (method).

Plant-derived kairomones have been reported to be attractants of Thrips. For example, although p-anisaldehyde, ethyl nicotinate, benzaldehyde, o-anisaldehyde, β-farnesene, eugenol, 3-phenylpropylaldehyde, monoterpenes (such as geraniol, linalool, nerol, citronellol or eucalyptol) and monoterpene esters (such as isobornyl valerate, isobornyl pivalate or lavandulyl valerate) have been reported to be attractants of Frankliniella occidentalis, the degree of that attraction varies (Non Patent Document 3; Non Patent Document 4; Non Patent Document 5; Non Patent Document 6; Patent Document 6; Patent Document 7; Patent Document 8).

In addition, ethyl nicotinate and benzaldehyde have been reported to show attractiveness to Thrips obscuratus, while anisaldehyde and benzaldehyde have been reported to show attractiveness to Thrips tabaci. In addition, although methyl anthranilate and ethyl anthranilate have been reported to attract Thrips hawaiiensis and Thrips coloratus, they have been reported to not attract Frankliniella occidentalis or Thrips tabaci (Non Patent Document 3; Non Patent Document 7; Non Patent Document 9). Analogues of plant-derived kairomones refer to compounds that show kairomone-like activity but are not derived from plants. For example, ethyl nicotinate and methyl m-aminobenzoate are analogues of plant-derived compounds in the form of methyl nicotinate and methyl o-aminobenzoate, respectively, and although they are not plant-derived compounds, they have been reported to be attractants of Thrips (Non Patent Document 3; Non Patent Document 5; Non Patent Document 7; Non Patent Document 8).

In addition to plant-derived aromatic compounds, synthetic pyridine derivative compounds (methyl isonicotinate, ethyl isonicotinate, propyl isonicotinate, isopropyl isonicotinate, decyl isonicotinate, ethyl 2-chloroisonicotinate, 4-(1,3-dioxolan-2-yl) pyridine, di-isopropyl isonicotinamide, 4-formyl pyridine, methyl 4-pyridyl ketone, ethyl 4-pyridyl ketone, propyl 4-pyridyl ketone) have been reported to show attractiveness to Thrips tabaci, Frankliniella occidentalis and Thrips obscuratus (Patent Document 6; Patent Document 7).

The above-mentioned chemicals may show attractiveness to different degrees depending on the type of Thrips, and have been reported to show species specificity.

However, high attractiveness does not show to noxious arthropods when using the above-mentioned attractants alone. Moreover, when using alone, there were cases in which high attractiveness does not show simultaneously to multiple species of noxious arthropods, and these attractants were inadequate for use as control methods against noxious arthropods (such as Thrips).

### CITATION LIST

### Patent Literature Document

Patent Document 1: JP Hei 7-242506A
Patent Document 2: JP Hei 9-124409A
Patent Document 3: JP Hei 3-188005A
Patent Document 4: JP Hei 6-234603A
Patent Document 5: JP Hei 9-194303A
Patent Document 6: JP 2011-264654A
Patent Document 7: Japanese Patent Publication 2006-539420
Patent Document 8: WO 03/055309

### Non-Patent Literature Document

Non-Patent Document 1: M. Hori, (2009) Journal of Applied Entomology, 133, 438-443.
Non-Patent Document 2: T. Fujii, M. Hori and K. Matsuda, (2010) Agricultural and Forest Entomology, 12, 99-105.
Non-Patent Document 3: D. A. J. Teulon, D. R. Penman and P. M. J. Ramakers, (1993) Journal of Economic Entomology, 86, 1405-1415.
Non-Patent Document 4: H. F. Brdsgaard, WPRS Bull., (1990) XI 11, 36.
Non-Patent Document 5: D. A. J. Teulon, B. Hollister and E. A. Cameron, (1993) IBOCIWPRS Bull., 16, 177-180.
Non-Patent Document 6: E. H. Koschier, W. J. D. Kogel and J. H. Visser, (2000) Journal of Chemical Ecology, 26, 2643-2655.
Non-Patent Document 7: D. R, Penman, G. O. Osborne, S. P. Worner, R. B. Chapman and G. F. McLaren, (1982) Journal of Chemical Ecology, 8, 1299-1303.
Non-Patent Document 8: T. Murai, T. Imai and M. Maekawa, (2000) Journal of Chemical Ecology, 26, 2557-2565.
Non-Patent Document 9: T. Imai, M. Maekawa and T. Murai, (2001) Applied Entomology and Zoology, 36, 475-478.

### SUMMARY OF THE INVENTION

### Technical Problem

As has been described above, the background art does not disclose substances that show a fixed level of action and effects in terms of attracting arthropods that are noxious to plants and are not necessarily satisfactory. Thus, an object of the present invention is to provide a means capable of attracting noxious arthropods more powerfully than the compositions described in the prior art references, more effectively controlling the behavior of noxious arthropod populations as a result thereof, and in particular, controlling and/or forecasting damage to plants caused by noxious arthropods.

### Solution Problem

The inventors of the present invention conducted research for enhancing attracting effects on noxious arthropods in order to solve the above-mentioned object or problems. More specifically, as a result of examining the effects of the weight of various compounds showing significant attractiveness on noxious arthropods for the purpose of protecting plants by controlling noxious arthropods, it was clearly determined that the weight at which each compound shows significant attractiveness varies for each compound.

On the basis of this finding, when studies were conducted on chemicals and combinations thereof showing significant attractiveness on noxious arthropods, in the case of combining two or more types of known attractant compounds, synergistic effect was found to be demonstrated that far surpassed the case of using a single compound with respect to attracting noxious arthropods.

Thus, according to the present invention, a noxious arthropod attractant composition that solves the above-mentioned problems by containing at least two types of compounds selected from the group of compounds selected from plant-derived kairomones and analogues thereof consisting of p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde.

### Advantageous Effects of Invention

As has been previously described, since the composition of the present invention has a superior noxious arthropod attracting effect, it makes it possible to efficiently attract and capture noxious arthropods, efficiently inhibit the density of noxious arthropods that cause damage to crops, or predict the seasonal variations in emergence of noxious arthropods. The control of noxious arthropods by using the above-mentioned composition for the purpose of demonstrating such actions and effects makes it possible to effectively protect various types of plants.

In the present invention, the phrase “synergistic effect” refers to an action by which the attracting effect of a composition combining compounds selected from two or more types of plant-derived kairomones and analogues thereof on a specific noxious arthropod population is significantly higher than the effect expected of that composition. In general, a synergistic attracting effect expected when mixing two given types of active ingredient compounds and using for treatment is determined from Colby's equation indicated with the following Equation 1:

E=X+Y−(X*Y)/100 (1)

wherein,

X: attraction rate when treated with attractive compound A;

Y: attraction rate when treated with attractive compound B; and

E: attraction rate expected when treating by mixing attractive compound A and attractive compound B (expected attraction rate value).

In the case the attraction rates of two types of combined compounds are equal to or greater than the expected attraction rate value, the compounds are considered to show a synergistic attracting effect (refer to S. R. Colby, (1967) Weeds, 15, 20-22).

Similarly, a synergistic attracting effect expected when mixing three given types of attractive compounds and using for treatment is determined from Colby's equation indicated with the following Equation 2:

E=X+Y+Z−(X*Y+X*Z+Y*Z)/100+X*Y*Z/10000 (2)

wherein,

X: attraction rate when treated with attractive compound A;

Y: attraction rate when treated with attractive compound B;

Z: attraction rate when treated with attractive compound C; and

E: attraction rate expected when treating by mixing attractive compound A, attractive compound B and attractive compound C (expected attraction rate value).

In the case the attraction rates of three types of combined compounds are equal to or greater than the expected attraction rate value, the compounds are considered to show a synergistic attracting effect (refer to above reference).

This type of effect can be easily confirmed by carrying out laboratory bioassays or field testing. Thus, if it were possible to confirm this effect, then any ratios may be used for the ratios of a combination of compounds selected from two or more plant-derived kairomones and analogues thereof. However, in the case of a combination of two types of compounds, for example, although there are no particular limitations thereon, the weight ratio of the combination of two types of compounds can be 0.0999 to 99.9001:99.9001 to 0.0999, preferably 0.1996 to 99.8004:99.8004 to 0.1996, and more preferably 0.99 to 90.01:90.01 to 0.99.

The weight ratio of the above-mentioned combination of three types of compound is such that, in the case of a combination of three types of compounds, for example, although there are no particular limitations thereon, the weight ratio of the combination of three types of compounds can be 0.0998 to 99.8004:99.8004 to 0.0998:0.0998 to 99.8004, preferably 0.1992 to 99.6016:99.6016 to 0.1992:0.1992 to 99.6016, and more preferably 0.98039 to 98.03922:98.03922 to 0.98039: 0.98039 to 98.03922.

All chemicals used in the present invention are known compounds, and these compounds can be obtained from commercially available preparations or can be synthesized according to known methods. The composition of the present invention can be used by using a mixture of the above-mentioned two or more types of plant-derived kairomones and analogues thereof at the above-mentioned mixing ratios either as is or after preparing a solution thereof by dissolving in a suitable solvent such as hexane, xylene, acetone or dichloromethane, and impregnating a suitable support such as paper or cloth with this solution. In addition, the above-mentioned two or more types of attracting compounds can also be used by preparing separately and combining at the same location.

A trap that uses the composition of the present invention as an attracting source can be used by setting up at a location where noxious arthropods inhabit or in an area in which they fly, namely indoors, within a facility or outdoors.

The composition of the present invention can also be used as a method for forecasting damage to plants caused by noxious arthropods or as a method for suppressing that damage to a minimum.

The present invention is a noxious arthropod attractant composition in which plant-derived kairomones or analogues thereof, used for the purpose of protecting plants by attracting noxious arthropods, are at least two types selected from the group consisting of p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde.

The composition of the present invention is a composition comprising two types of compounds selected from compound groups selected from the plant-derived kairomones and analogues thereof described in claim 1, and examples thereof which can be used include:
1) o-anisidine and o-aminoacetophenone,
2) o-anisidine and p-anisaldehyde,
3) p-anisaldehyde and ethyl nicotinate,
4) p-anisaldehyde and methyl m-aminobenzoate,
5) p-anisaldehyde and methyl benzoate,
6) p-anisaldehyde and o-aminoacetophenone,
7) p-anisaldehyde and methyl o-toluate,
8) p-anisaldehyde and methyl anthranilate,
9) p-anisaldehyde and citronellol,
10) ethyl nicotinate and methyl m-aminobenzoate,
11) ethyl nicotinate and methyl benzoate,
12) ethyl nicotinate and o-aminoacetophenone,
13) ethyl nicotinate and citronellol,
14) ethyl nicotinate and methyl o-toluate,
15) ethyl nicotinate and methyl anthranilate,
16) methyl m-aminobenzoate and citronellol,
17) methyl m-aminobenzoate and methyl anthranilate,
18) methyl benzoate and citronellol,
19) citronellol and methyl anthranilate,
20) ethyl nicotinate and o-anisidine,
21) citronellol and o-aminoacetophenone,
22) citronellol and o-anisidine,
23) citronellol and o-methyl toluate,
24) methyl anthranilate and o-aminoacetophenone,
25) methyl anthranilate and o-anisidine,
26) methyl anthranilate and methyl o-toluate,
27) methyl benzoate and o-aminoacetophenone,
28) methyl benzoate and o-anisidine,
29) methyl benzoate and methyl m-aminobenzoate,
30) methyl benzoate and o-methyl toluate,
31) o-aminoacetophenone and methyl m-aminobenzoate,
32) o-aminoacetophenone and methyl o-toluate,
33) methyl m-aminobenzoate and methyl o-toluate,
34) o-anisidine and methyl m-aminobenzoate,
35) o-anisidine and methyl o-toluate,
36) methyl benzoate and methyl anthranilate,
37) ethyl nicotinate and geraniol,
38) methyl m-aminobenzoate and geraniol,
39) methyl benzoate and geraniol,
40) geraniol and citronellol,
41) geraniol and o-aminoacetophenone,
42) geraniol and o-anisidine,
43) geraniol and methyl o-toluate,
44) geraniol and methyl anthranilate,
45) p-anisaldehyde and geraniol,
46) benzaldehyde and geraniol,
47) geraniol and linalool,
48) geraniol and nerol,
49) geraniol and α-hexylcinnamaldehyde,
50) benzaldehyde and o-anisidine,
51) benzaldehyde and o-aminoacetophenone,
52) benzaldehyde and methyl benzoate,
53) p-anisaldehyde and α-hexylcinnamaldehyde,
54) p-anisaldehyde and nerol,
55) p-anisaldehyde and linalool,
56) ethyl nicotinate and α-hexylcinnamaldehyde,
57) ethyl nicotinate and nerol,
58) ethyl nicotinate and linalool,
59) methyl m-aminobenzoate and nerol,
60) methyl m-aminobenzoate and linalool,
61) methyl benzoate and α-hexylcinnamaldehyde,
62) methyl benzoate and nerol,
63) methyl benzoate and linalool,
64) nerol and methyl anthranilate,
65) linalool and methyl anthranilate,
66) p-anisaldehyde and benzaldehyde,
67) benzaldehyde and ethyl nicotinate,
68) benzaldehyde and citronellol,
69) benzaldehyde and methyl anthranilate,
70) benzaldehyde and methyl m-aminobenzoate,
71) benzaldehyde and methyl o-toluate,
72) linalool and citronellol,
73) linalool and o-aminoacetophenone,
74) linalool and o-anisidine,
75) linalool and methyl o-toluate,
76) nerol and citronellol,
77) nerol and o-aminoacetophenone,
78) nerol and o-anisidine,
79) nerol and methyl o-toluate,
80) citronellol and α-hexylcinnamaldehyde,
81) methyl anthranilate and α-hexylcinnamaldehyde,
82) o-aminoacetophenone and α-hexylcinnamaldehyde,
83) o-anisidine and α-hexylcinnamaldehyde,
84) methyl m-aminobenzoate and α-hexylcinnamaldehyde,
85) methyl o-toluate and α-hexylcinnamaldehyde,
86) linalool and nerol,
87) benzaldehyde and α-hexylcinnamaldehyde,
88) linalool and α-hexylcinnamaldehyde,
89) nerol and α-hexylcinnamaldehyde,
90) benzaldehyde and linalool, and
91) benzaldehyde and nerol.

The composition of the present invention is a composition comprising three types of compounds selected from compound groups selected from the plant-derived kairomones and analogues thereof described in claim 1, and examples thereof which can be used include:

1) p-anisaldehyde, ethyl nicotinate and methyl m-aminobenzoate,

2) p-anisaldehyde, ethyl nicotinate and methyl benzoate,

3) p-anisaldehyde, ethyl nicotinate and o-aminoacetophenone,

4) p-anisaldehyde, ethyl nicotinate and citronellol,

5) p-anisaldehyde, ethyl nicotinate and methyl o-toluate,

6) p-anisaldehyde, ethyl nicotinate and methyl anthranilate,

7) p-anisaldehyde, methyl benzoate and methyl m-aminobenzoate,

8) p-anisaldehyde, methyl benzoate and o-aminoacetophenone,

9) p-anisaldehyde, methyl benzoate and citronellol,

10) p-anisaldehyde, methyl benzoate and methyl o-toluate,

11) p-anisaldehyde, methyl benzoate and methyl anthranilate,

12) p-anisaldehyde, methyl anthranilate and methyl m-aminobenzoate,

13) p-anisaldehyde, methyl anthranilate and methyl benzoate,

14) p-anisaldehyde, methyl anthranilate and o-aminoacetophenone,

15) p-anisaldehyde, methyl anthranilate and citronellol,

16) ethyl nicotinate, methyl benzoate and citronellol,

17) ethyl nicotinate, methyl anthranilate and methyl m-aminobenzoate,

18) ethyl nicotinate, methyl anthranilate and methyl benzoate,

19) ethyl nicotinate, methyl anthranilate and citronellol,

20) ethyl nicotinate, methyl anthranilate and o-anisidine,

21) p-anisaldehyde, methyl anthranilate and methyl o-toluate,

22) ethyl nicotinate, methyl benzoate and methyl m-aminobenzoate,

23) ethyl nicotinate, methyl benzoate and o-aminoacetophenone,

24) ethyl nicotinate, methyl benzoate and methyl o-toluate,

25) ethyl nicotinate, methyl anthranilate and o-aminoacetophenone,

26) ethyl nicotinate, methyl anthranilate and methyl o-toluate,

27) methyl benzoate, methyl anthranilate and methyl m-aminobenzoate,

28) methyl benzoate, methyl anthranilate and o-aminoacetophenone,

29) methyl benzoate, methyl anthranilate and citronellol,

30) methyl benzoate, methyl anthranilate and methyl o-toluate,

31) o-aminoacetophenone, methyl m-aminobenzoate and citronellol,

32) o-aminoacetophenone, methyl m-aminobenzoate and methyl o-toluate,

33) p-anisaldehyde, methyl m-aminobenzoate and o-aminoacetophenone,

34) ethyl nicotinate, methyl m-aminobenzoate and o-anisidine,

35) ethyl nicotinate, methyl benzoate and o-anisidine,

36) p-anisaldehyde, ethyl nicotinate and geraniol,

37) p-anisaldehyde, methyl benzoate and geraniol,

38) p-anisaldehyde, methyl anthranilate and geraniol,

39) ethyl nicotinate, methyl benzoate and geraniol,

40) ethyl nicotinate, methyl anthranilate and geraniol,

41) methyl benzoate, methyl anthranilate and geraniol,

42) o-aminoacetophenone, methyl anthranilate and geraniol,

43) p-anisaldehyde, ethyl nicotinate and α-hexylcinnamaldehyde,

44) p-anisaldehyde, ethyl nicotinate and nerol,

45) p-anisaldehyde, ethyl nicotinate and linalool,

46) p-anisaldehyde, methyl benzoate and α-hexylcinnamaldehyde,

47) p-anisaldehyde, methyl benzoate and nerol,

48) p-anisaldehyde, methyl benzoate and linalool,

49) p-anisaldehyde, methyl benzoate and benzaldehyde,

50) p-anisaldehyde, methyl anthranilate and α-hexylcinnamaldehyde,

51) p-anisaldehyde, methyl anthranilate and nerol,

52) ethyl nicotinate, methyl anthranilate and linalool,

53) ethyl nicotinate, methyl benzoate and nerol,

54) ethyl nicotinate, methyl benzoate and linalool,

55) ethyl nicotinate, methyl anthranilate and benzaldehyde,

56) ethyl nicotinate, methyl anthranilate and nerol,

57) ethyl nicotinate, methyl anthranilate and linalool,

58) ethyl nicotinate, methyl benzoate and α-hexylcinnamaldehyde,

59) ethyl nicotinate, methyl anthranilate and α-hexylcinnamaldehyde,

60) methyl benzoate, methyl anthranilate and nerol,

61) p-anisaldehyde, α-hexylcinnamaldehyde and methyl m-aminobenzoate,

62) p-anisaldehyde, α-hexylcinnamaldehyde and methyl benzoate,

63) p-anisaldehyde, α-hexylcinnamaldehyde and o-amino acetophenone,

64) p-anisaldehyde, α-hexylcinnamaldehyde and citronellol,

65) p-anisaldehyde, α-hexylcinnamaldehyde and methyl o-toluate,

66) ethyl nicotinate, α-hexylcinnamaldehyde and methyl m-aminobenzoate,

67) ethyl nicotinate, α-hexylcinnamaldehyde and methyl benzoate,

68) ethyl nicotinate, α-hexylcinnamaldehyde and o-aminoacetop henone,

69) ethyl nicotinate, α-hexylcinnamaldehyde and citronellol,

70) ethyl nicotinate, α-hexylcinnamaldehyde and methyl o-toluate,

71) methyl benzoate, methyl anthranilate and linalool,

72) nerol, citronellol and p-anisaldehyde,

73) nerol, citronellol and ethyl nicotinate,

74) nerol, citronellol and methyl m-aminobenzoate,

75) nerol, citronellol and o-aminoacetophenone,

76) nerol, citronellol and methyl benzoate,

77) nerol, citronellol and methyl o-toluate,

78) nerol, citronellol and methyl anthranilate,

79) methyl anthranilate, α-hexylcinnamaldehyde and o-amino acetophenone,

80) methyl anthranilate, α-hexylcinnamaldehyde and citronellol,

81) methyl anthranilate, α-hexylcinnamaldehyde and methyl o-toluate,

82) α-hexylcinnamaldehyde, methyl m-aminobenzoate and citronellol,

83) benzaldehyde, methyl anthranilate and citronellol,

84) methyl anthranilate, benzaldehyde and methyl o-toluate,

85) benzaldehyde, ethyl nicotinate and o-aminoacetophenone,

86) nerol, methyl anthranilate and methyl o-toluate,

87) p-anisaldehyde, benzaldehyde and methyl m-aminobenzoate,

88) o-aminoacetophenone, methyl m-aminobenzoate and nerol,

89) o-aminoacetophenone, methyl m-aminobenzoate and linalool,

90) benzaldehyde, ethyl nicotinate and o-anisidine,

91) p-anisaldehyde, benzaldehyde, ethyl nicotinate,

92) p-anisaldehyde, benzaldehyde and o-anisidine,

93) geraniol, linalool and p-anisaldehyde,

94) ethyl nicotinate, α-hexylcinnamaldehyde and geraniol,

95) geraniol, linalool and citronellol,

96) p-anisaldehyde, α-hexylcinnamaldehyde and geraniol,

97) nerol, citronellol and geraniol,

98) methyl anthranilate, α-hexylcinnamaldehyde and geraniol,

99) methyl anthranilate, α-hexylcinnamaldehyde and nerol,

100) methyl anthranilate, α-hexylcinnamaldehyde and linalool,

101) p-anisaldehyde, α-hexylcinnamaldehyde and nerol,

102) p-anisaldehyde, α-hexylcinnamaldehyde and linalool,

103) ethyl nicotinate, α-hexylcinnamaldehyde and nerol,

104) ethyl nicotinate, α-hexylcinnamaldehyde and linalool,

105) nerol, citronellol and benzaldehyde,

106) nerol, citronellol and α-hexylcinnamaldehyde, and

107) nerol, citronellol and linalool.

The composition of the present invention is not limited only to a composition comprising two types or three types of compounds selected from compound groups selected from the plant-derived kairomones and analogues thereof described in claim 1. Namely, the composition of the present invention can be a composition comprising four types of plant-derived kairomones and analogues thereof selected from the plant kairomones and analogues thereof described in the claims, and examples thereof which can be used include:

1) a composition composed of p-anisaldehyde, ethyl nicotinate, methyl m-aminobenzoate and methyl benzoate,

2) a composition composed of p-anisaldehyde, ethyl nicotinate, methyl m-aminobenzoate and o-anisidine,

3) a composition composed of p-anisaldehyde, ethyl nicotinate, methyl m-aminobenzoate and o-aminoacetophenone,

4) a composition composed of p-anisaldehyde, ethyl nicotinate, methyl benzoate and o-anisidine,

5) a composition composed of p-anisaldehyde, ethyl nicotinate, methyl benzoate and o-aminoacetophenone,

6) a composition composed of p-anisaldehyde, ethyl nicotinate, o-anisidine and o-aminoacetophenone,

7) a composition composed of p-anisaldehyde, methyl m-aminobenzoate, methyl benzoate and o-anisidine,

8) a composition composed of p-anisaldehyde, methyl m-aminobenzoate, methyl benzoate and o-aminoacetophenone,

9) a composition composed of p-anisaldehyde, methyl m-aminobenzoate, o-anisidine and o-aminoacetophenone,

10) a composition composed of p-anisaldehyde, methyl benzoate, o-anisidine and o-aminoacetophenone,

11) a composition composed of ethyl nicotinate, methyl m-aminobenzoate, methyl benzoate and o-anisidine,

12) a composition composed of ethyl nicotinate, methyl m-aminobenzoate, methyl benzoate and o-aminoacetophenone,

13) a composition composed of ethyl nicotinate, methyl m-aminobenzoate, o-anisidine and o-aminoacetophenone,

14) a composition composed of ethyl nicotinate, methyl benzoate, o-anisidine and o-aminoacetophenone,

15) a composition composed of methyl m-aminobenzoate, methyl benzoate, o-anisidine and o-aminoacetophenone,

16) a composition composed of p-anisaldehyde, benzaldehyde, ethyl nicotinate and methyl m-aminobenzoate,

17) a composition composed of p-anisaldehyde, benzaldehyde, ethyl nicotinate and methyl benzoate,

18) a composition composed of p-anisaldehyde, benzaldehyde, ethyl nicotinate and o-anisidine,

19) a composition composed of p-anisaldehyde, benzaldehyde, ethyl nicotinate and o-aminoacetophenone,

20) a composition composed of p-anisaldehyde, benzaldehyde, methyl m-aminobenzoate and methyl benzoate,

21) a composition composed of p-anisaldehyde, benzaldehyde, methyl m-aminobenzoate and o-anisidine,

22) a composition composed of p-anisaldehyde, benzaldehyde, methyl m-aminobenzoate and o-aminoacetophenone,

23) a composition composed of p-anisaldehyde, benzaldehyde, methyl benzoate and o-anisidine,

24) a composition composed of p-anisaldehyde, benzaldehyde, methyl benzoate and o-aminoacetophenone,

25) a composition composed of p-anisaldehyde, benzaldehyde, o-anisidine and o-aminoacetophenone,

26) a composition composed of benzaldehyde, ethyl nicotinate, methyl m-aminobenzoate and methyl benzoate,

27) a composition composed of benzaldehyde, ethyl nicotinate, methyl m-aminobenzoate and o-anisidine,

28) a composition composed of benzaldehyde, ethyl nicotinate, methyl m-aminobenzoate and o-aminoacetophenone,

29) a composition composed of benzaldehyde, ethyl nicotinate, methyl benzoate and o-anisidine,

30) a composition composed of benzaldehyde, ethyl nicotinate, methyl benzoate and o-aminoacetophenone,

31) a composition composed of benzaldehyde, ethyl nicotinate, o-anisidine and o-aminoacetophenone,

32) a composition composed of benzaldehyde, methyl m-aminobenzoate, methyl benzoate and o-anisidine,

33) a composition composed of benzaldehyde, methyl m-aminobenzoate, methyl benzoate and o-aminoacetophenone,

34) a composition composed of benzaldehyde, methyl m-aminobenzoate, o-anisidine and o-aminoacetophenone, and

35) a composition composed of benzaldehyde, methyl benzoate, o-anisidine and o-aminoacetophenone.

The composition of the present invention is not limited only to a composition comprising two types or three types of compounds selected from compound groups selected from the plant-derived kairomones and analogues thereof described in claim 1. Namely, the composition of the present invention can be a composition comprising five types of plant-derived kairomones and analogues thereof selected from the plant kairomones and analogues thereof described in the claims, and examples thereof which can be used include:

1) a composition composed of ethyl nicotinate, methyl m-aminobenzoate, methyl benzoate, o-anisidine and o-aminoacetophenone,

2) a composition composed of p-anisaldehyde, ethyl nicotinate, methyl m-aminobenzoate, methyl benzoate and o-aminoacetophenone,

3) a composition composed of p-anisaldehyde, ethyl nicotinate, methyl m-aminobenzoate, o-anisidine and o-aminoacetophenone,

4) a composition composed of p-anisaldehyde, ethyl nicotinate, methyl benzoate, o-anisidine and o-aminoacetophenone,

5) a composition composed of p-anisaldehyde, methyl m-aminobenzoate, methyl benzoate, o-anisidine and o-aminoacetophenone,

6) a composition composed of p-anisaldehyde, ethyl nicotinate, methyl m-aminobenzoate, methyl benzoate and o-anisidine,

7) a composition composed of p-anisaldehyde, benzaldehyde, ethyl nicotinate, methyl m-aminobenzoate and methyl benzoate,

8) a composition composed of p-anisaldehyde, benzaldehyde, ethyl nicotinate, methyl m-aminobenzoate and o-anisidine,

9) a composition composed of p-anisaldehyde, benzaldehyde, ethyl nicotinate, methyl m-aminobenzoate and o-aminoacetophenone,

10) a composition composed of p-anisaldehyde, benzaldehyde, ethyl nicotinate, methyl benzoate and o-anisidine,

11) a composition composed of p-anisaldehyde, benzaldehyde, ethyl nicotinate, methyl benzoate and o-aminoacetophenone,

12) a composition composed of p-anisaldehyde, benzaldehyde, ethyl nicotinate, o-anisidine and o-aminoacetophenone,

13) a composition composed of p-anisaldehyde, benzaldehyde, methyl m-aminobenzoate, methyl benzoate and o-anisidine,

14) a composition composed of p-anisaldehyde, benzaldehyde, methyl m-aminobenzoate, methyl benzoate and o-aminoacetophenone,

15) a composition composed of p-anisaldehyde, benzaldehyde, methyl m-aminobenzoate, o-anisidine and o-aminoacetophenone,

16) a composition composed of p-anisaldehyde, benzaldehyde, methyl benzoate, o-anisidine and o-aminoacetophenone,

17) a composition composed of benzaldehyde, ethyl nicotinate, methyl m-aminobenzoate, methyl benzoate and o-anisidine,

18) a composition composed of benzaldehyde, ethyl nicotinate, methyl m-aminobenzoate, methyl benzoate and o-aminoacetophenone,

19) a composition composed of benzaldehyde, ethyl nicotinate, methyl m-aminobenzoate, o-anisidine and o-aminoacetophenone,

20) a composition composed of benzaldehyde, ethyl nicotinate, methyl benzoate, o-anisidine and o-aminoacetophenone, and

21) a composition composed of benzaldehyde, methyl m-aminobenzoate, methyl benzoate, o-anisidine and o-aminoacetophenone.

The composition of the present invention is not limited only to a composition comprising two types or three types of compounds selected from compound groups selected from the plant-derived kairomones and analogues thereof described in claim 1. Namely, the composition of the present invention can be a composition comprising six types of plant-derived kairomones and analogues thereof selected from the plant kairomones and analogues thereof described in the claims, and examples thereof which can be used include:

1) a composition composed of p-anisaldehyde, ethyl nicotinate, methyl m-aminobenzoate, methyl benzoate, o-anisidine and o-aminoacetophenone,

2) a composition composed of p-anisaldehyde, benzaldehyde, ethyl nicotinate, methyl m-aminobenzoate, methyl benzoate and o-aminoacetophenone,

3) a composition composed of p-anisaldehyde, benzaldehyde, ethyl nicotinate, methyl m-aminobenzoate, o-anisidine and o-aminoacetophenone,

4) a composition composed of p-anisaldehyde, benzaldehyde, ethyl nicotinate, methyl benzoate, o-anisidine and o-aminoacetophenone,

5) a composition composed of p-anisaldehyde, benzaldehyde, methyl m-aminobenzoate, methyl benzoate, o-anisidine and o-aminoacetophenone,

6) a composition composed of p-anisaldehyde, benzaldehyde, ethyl nicotinate, methyl m-aminobenzoate, methyl benzoate and o-anisidine, and

7) a composition composed of benzaldehyde, ethyl nicotinate, methyl m-aminobenzoate, methyl benzoate, o-anisidine and o-aminoacetophenone.

The composition of the present invention is not limited only to a composition comprising two types or three types of compounds selected from compound groups selected from the plant-derived kairomones and analogues thereof described in claim 1. Namely, the composition of the present invention can be a composition comprising seven types of plant-derived kairomones and analogues thereof selected from the plant-derived kairomones and analogues thereof described in the claims, and examples thereof which can be used include:

1) a composition composed of p-anisaldehyde, methyl anthranilate, ethyl nicotinate, methyl m-aminobenzoate, methyl benzoate, methyl o-toluate and o-aminoacetophenone,

2) a composition composed of p-anisaldehyde, methyl anthranilate, ethyl nicotinate, methyl m-aminobenzoate, methyl benzoate, citronellol and o-aminoacetophenone,

3) a composition composed of p-anisaldehyde, methyl o-toluate, ethyl nicotinate, methyl m-aminobenzoate, methyl benzoate, citronellol and o-aminoacetophenone,

4) a composition composed of p-anisaldehyde, benzaldehyde, ethyl nicotinate, methyl m-aminobenzoate, methyl benzoate, o-anisidine and o-aminoacetophenone,

5) a composition composed of p-anisaldehyde, benzaldehyde, ethyl nicotinate, methyl m-aminobenzoate, methyl benzoate, citronellol and o-aminoacetophenone,

6) a composition composed of p-anisaldehyde, benzaldehyde, ethyl nicotinate, methyl m-aminobenzoate, methyl benzoate, methyl o-toluate and o-aminoacetophenone,

7) a composition composed of p-anisaldehyde, benzaldehyde, ethyl nicotinate, methyl m-aminobenzoate, methyl benzoate, methyl anthranilate and o-aminoacetophenone,

8) a composition composed of p-anisaldehyde, benzaldehyde, ethyl nicotinate, o-anisidine, methyl benzoate, methyl o-toluate and o-aminoacetophenone,

9) a composition composed of p-anisaldehyde, benzaldehyde, ethyl nicotinate, o-anisidine, methyl benzoate, methyl anthranilate and o-aminoacetophenone,

10) a composition composed of p-anisaldehyde, benzaldehyde, ethyl nicotinate, o-anisidine, methyl benzoate, citronellol and o-aminoacetophenone,

11) a composition composed of p-anisaldehyde, benzaldehyde, ethyl nicotinate, methyl m-aminobenzoate, methyl benzoate, nerol and o-aminoacetophenone,

12) a composition composed of p-anisaldehyde, benzaldehyde, ethyl nicotinate, methyl m-aminobenzoate, methyl benzoate, linalool and o-aminoacetophenone,

13) a composition composed of p-anisaldehyde, benzaldehyde, ethyl nicotinate, methyl m-aminobenzoate, methyl benzoate, α-hexylcinnamaldehyde and o-aminoacetophenone,

14) a composition composed of p-anisaldehyde, benzaldehyde, ethyl nicotinate, o-anisidine, methyl benzoate, geraniol and o-aminoacetophenone, and

15) a composition composed of p-anisaldehyde, benzaldehyde, ethyl nicotinate, methyl m-aminobenzoate, methyl benzoate, geraniol and o-aminoacetophenone.

The composition of the present invention is not limited only to a composition comprising two types or three types of compounds selected from compound groups selected from the plant-derived kairomones and analogues thereof described in claim 1. Namely, the composition of the present invention can be a composition comprising eight types of plant-derived kairomones and analogues thereof selected from the plant-derived kairomones and analogues thereof described in the claims, and examples thereof which can be used include:

1) a composition composed of p-anisaldehyde, citronellol, ethyl nicotinate, methyl m-aminobenzoate, methyl benzoate, o-anisidine, o-aminoacetophenone and methyl anthranilate,

2) a composition composed of p-anisaldehyde, citronellol, ethyl nicotinate, methyl m-aminobenzoate, methyl benzoate, o-anisidine, o-aminoacetophenone and methyl o-toluate,

3) a composition composed of p-anisaldehyde, methyl anthranilate, ethyl nicotinate, methyl m-aminobenzoate, methyl benzoate, o-anisidine, o-aminoacetophenone and methyl o-toluate,

4) a composition composed of p-anisaldehyde, benzaldehyde, ethyl nicotinate, methyl m-aminobenzoate, methyl benzoate, o-anisidine, o-aminoacetophenone and citronellol,

5) a composition composed of p-anisaldehyde, benzaldehyde, ethyl nicotinate, methyl m-aminobenzoate, methyl benzoate, o-anisidine, o-aminoacetophenone and methyl anthranilate,

6) a composition composed of p-anisaldehyde, benzaldehyde, ethyl nicotinate, methyl m-aminobenzoate, methyl benzoate, o-anisidine, o-aminoacetophenone and methyl o-toluate,

7) a composition composed of p-anisaldehyde, benzaldehyde, ethyl nicotinate, methyl m-aminobenzoate, methyl benzoate, o-anisidine, o-aminoacetophenone and nerol,

8) a composition composed of p-anisaldehyde, benzaldehyde, ethyl nicotinate, methyl m-aminobenzoate, methyl benzoate, o-anisidine, o-aminoacetophenone and α-hexylcinnamaldehyde,

9) a composition composed of p-anisaldehyde, benzaldehyde, ethyl nicotinate, methyl m-aminobenzoate, methyl benzoate, o-anisidine, o-aminoacetophenone and linalool,

10) a composition composed of p-anisaldehyde, benzaldehyde, ethyl nicotinate, methyl m-benzoate, methyl benzoate, o-anisidine, o-aminoacetophenone and geraniol,

11) a composition composed of p-anisaldehyde, benzaldehyde, ethyl nicotinate, methyl anthranilate, methyl benzoate, o-anisidine, o-aminoacetophenone and geraniol,

12) a composition composed of p-anisaldehyde, benzaldehyde, ethyl nicotinate, methyl m-aminobenzoate, methyl benzoate, methyl anthranilate, o-aminoacetophenone and geraniol,

13) a composition composed of p-anisaldehyde, benzaldehyde, ethyl nicotinate, methyl o-toluate, methyl benzoate, o-anisidine, o-aminoacetophenone and geraniol, and

14) a composition composed of p-anisaldehyde, benzaldehyde, ethyl nicotinate, methyl m-aminobenzoate, methyl benzoate, o-methyl toluate, o-aminoacetophenone and geraniol.

The p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde used in the present invention are known compounds, and these compounds are obtained from commercially available preparations or are obtained by producing according to known methods.

The p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde used in the present invention are known to be chemicals and analogues thereof produced and released by plants.

Known attracting components may also be contained in the composition of the present invention as noxious arthropod attractants other than the chemicals described in the claims, examples of which include ethyl isonicotinate, methyl isonicotinate, propyl isonicotinate, isopropyl isonicotinate, ethyl 2-chloroisonicotinate, 4-(1,3-dioxolan-2-y) pyridine, di-isopropyl isonicotinamide, 4-formyl pyridine, methyl 4-pyridyl ketone, ethyl 4-pyridyl ketone, propyl 4-pyridyl ketone, neryl (S)-2-methylbutanoate, lavandulyl acetate, leaf alcohol, leaf aldehyde and leaf acetate.

The population of noxious arthropods can be investigated by counting the number of captured organisms. The need for control is judged based on estimated population density. A method for removing noxious arthropods provided by the present invention is required to capture a large number of noxious arthropods. Conversely, rapid control is not necessarily required in the case of the low density of noxious arthropods.

For example, the composition of the present invention can be set up in a trap. This type of trap is designed to as to release an effective amount of an attractant. The trap is set up at a location where noxious arthropods are present or are predicted to be present. The attractant attracts noxious arthropods to the trap. Subsequently, by setting up an insecticide in the trap that shows lethal effects on noxious arthropods, for example, noxious arthropods attracted into the trap can be eradicated. Alternatively, noxious arthropods can also be attracted and captured by inserting an adhesive sheet. The following describes examples of effective insecticidal active ingredients able to be incorporated with the composition of the present invention.

Effective insecticidal active ingredients:

o-ethyl o-4-nitrophenyl phenylphosphonothionate (EPN), acephate, isoxathion, isofenphos, isoprocarb, etrimfos, oxydeprofos, quinalphos, cadusafos, chlorethoxyfos, chlorpyrifos, chlorpyrifos-methyl, chlorofenvinphos, salithion, cyanophos, disulfoton, dimethoate, sulfprofos, diazinon, thiometon, tetrachlorvinphos, tebupirimfos, trichlorophon, naled, vamdothion, pyraclophos, pyridafenthion, pirimiphos-methyl, fenitrothion, fenthion, phenthoate, butathiofos, prothiofos, propaphos, profenofos, benclothiaz, phosalone, fosthiazate, malathion, methidathion, metolcarb, monocrotophos, fenobcarb (BMPC), 3,5-xylyl N-methylcarbamate (XMC), alanycarb, ethiofencarb, carbaryl, carbosulfan, carbofuran, xylylcarb, cloethocarb, thiodicarb, triazamate, pirimicarb, fenoxycarb, fenothiocarb, furathiocarb, propoxur, bendiocarb, benfuracarb, methomyl, acrinathrin, imiprothrin, ethofenprox, cycloprothrin, sigma-cypermethrin, cyhalothrin, cyfluthrin, cypermethrin, silafluofen, tefluthrin, deltamethrin, tralomethrin, fenvalerate, fenpropathrin, flucythrinate, fluvalinate, flufenoprox, fluproxyfen, profluthrin, beta-cyfluthrin, benfluthrin, permethrin, cartap, thiocyclam, bensultap, avermectin, emamectin-benzoate, chlorfluoazuron, cyromazine, diafenthiuron, dichlorvos, diflubenzuron, spynosyn, spiromesifen, teflubenzuron, tebufenozide, hydroprene, vaniliprole, pymetrozine, pyriproxyfen, fipronil, flufenoxuron, buprofezin, hexaflumuron, milbemycin, lufenuron, chlorphenapyr, pyridalyl, flufendiamide, SI-0009, metofluthrin, noviflumuron, dimefluthrin, cyflumetofen, pyrafluprole and pyriprole.

In addition, other insecticidal active ingredients or synergists (such as piperonyl butoxide, sesamex sulfoxide, MGK 264, N-decylimidazole, WARF-antiresistant, TBPT, TPP, IBP, PSCP, CH3I, t-phenylbutenone, diethyl maleate, DMC, FDMC, ETP or ETN) can be incorporated and suitably used with the composition of the present invention.

Examples of solid carriers used during formulation include fine powders or particulate matter composed of minerals such as kaolin clay, attapulgite clay, bentonite, montmorillonite, acid clay, pyrophyllite, talc, diatomaceous earth or calcite, natural organic matter such as powdered corn cob or walnut shells, synthetic organic matter such as urea, salts such as calcium carbonate or ammonium sulfate or synthetic inorganic matter such as synthetic water-containing silicon oxide, while examples of liquid carriers include aromatic hydrocarbons such as xylene, alkyl benzene or methyl naphthalene, alcohols such as 2-propanol, ethylene glycol, propylene glycol or ethylene glycol monoethyl ether, ketones such as acetone, cyclohexanone or isophorone, vegetable oils such as soybean oil or cottonseed oil, petroleum-based aliphatic hydrocarbons, esters, dimethylsulfoxide, acetonitrile and water.

Examples of surfactants include anionic surfactants such as alkyl sulfate ester salts, alkyl aryl sulfonates, dialkyl sulfosuccinates, polyoxyethylene alkyl aryl ether phosphate ester salts, lignin sulfonates or naphthalene sulfonate formaldehyde condensates, nonionic surfactants such as polyoxyethylene alkyl aryl ethers, polyoxyethylene alkyl polyoxypropylene block copolymers or sorbitan fatty acid esters, and cationic surfactants such as alkyl trimethyl ammonium salts.

Examples of other formulation assistants include water-soluble polymers such as polyvinyl alcohol or polyvinylpyrrolidone, polysaccharides such as gum arabic, alginic acid and salts thereof, carboxymethyl cellulose (CMC) or xanthan gum, inorganic matter such as aluminum magnesium silicate or alumina sol, preservatives, colorants and stabilizers such as isopropyl acid phosphate (PAP) or BHT.

The present invention with attracting and capturing noxious arthropods is able to protect plants from noxious arthropods (e.g., noxious arthropods such as noxious insects or noxious mites) that cause damage by feeding on or sapping the following plants.

Forecasting and control methods using the composition of the present invention can be used in arable land or non-arable land such as fields, rice paddies, lawns or orchards. In addition, the present invention can be used to control noxious arthropods in arable land where the “plants” exemplified below are cultivated without causing chemical damage to those plants:

agricultural crops: corn (Zea mays), rice (Oryza saliva), wheat (Triticum aestivum), barley (Hordeum vulgare), rye (Secale cereale), oats (Avena saliva), sorghum (Sorghum bicolor (L.) Moenchi), cotton (Gossypium arboreum), soybeans (Glycine max), peanuts (Arachis hypogaea), buckwheat (Fagopyrum esculentum), beets (Beta vulgaris ssp. vulgaris), rape (Brassica rapa var. amplexicaulis), sunflowers (Helianthus annuus), sugar cane (Saccharum oficinarum), tobacco (Nicotiana tabacum);

vegetables: vegetables of the Solanaceae family such as eggplants (Solanum melongena), tomatoes (Solanum lycopersicum), green peppers (Capsicum annuum var. angulosum), red peppers (Capsicum annuum) or potatoes (Solanum tuberosum), vegetables of the Cucurbitaceae family such as cucumbers (Cucumis sativus), squash (Cucurbita maxima), zucchini (Cucurbita pepo), watermelon (Citrullus lanatus) or muskmelon (Cucumis meld), vegetables of the Brassicaceae family such as Japanese white radishes (Raphanus sativus var. longipinnatus), turnips (Brassica rapa L. var. glabra), horseradish (Armoracia rusticana), kohlrabi (Brassica oleracea var. gongylodes), Chinese cabbage (Brassica rapa var. pekinensis), cabbage (Brassica oleracea), mustard (Brassica juncea), broccoli (Brassica oleracea var. italica), cauliflower (Brassica oleracea var. botrytis) or colza (Brassica napus), vegetables of the Asteraceae family such as burdock (Arctium lappa), garland chrysanthemum (Glebionis coronaria) or artichokes (Cynara scolymus), lettuce (Lactuca sativa), vegetables of the Liliceae family such as green onions (Allium fistulosum), onions (Allium cepa), garlic (Allium sativum) or asparagus (Asparagus officinalis), vegetables of the Umbelliferae family such as carrots (Daucus carota), parsley (Petroselinum neapolitanum), celery (Apium graveolens var. dulce) or parsnips (Pastinaca sativa), vegetables of the Chenopodiaceae family such as spinach (Spinacia oleracea) or chard (Beta vulgaris var. cicla), vegetables of the Labiatae family such as perilla (Perilla frutescens var. crispa), mint (Mentha piperita) or basil (Ocimurn basilicum), strawberries (Fragaria ananassa Duchesne), sweet potatoes (Ipomoea batatas), Japanese yams (Dioscorea japonica) and taro (Colocasia esculenta);

fruits: pome fruits (apples (Malus pumila), pears (Pyrus communis), Japanese pears (Pyrus pyrifolia var. culta), Chinese quince (Chaenomeles sinensis), marmelo quince (Cydonia oblonga)), stone fruits (peaches (Amygdalus persica), Japanese plums (Prunus salicina), nectarines (Amygdalus persica var. nectarina), plums (Prunus mume), cherries (Cerasus avium), apricots (Prunus armeniaca), prunes (Prunus armeniaca)), citrus fruits (satsuma mandarins (Citrus unshiu), oranges (Citrus sinensis), lemons (Citrus limon), limes (Citrus aurantifolia), grapefruits (Citrus paradisi)), nuts (chestnuts (Castanea crenata), walnuts (Juglans mandshurica var. sieboldiana), hazelnuts (Corylus avellana), almonds (Prunus dulcis), pistachios (Pistacia vera), cashew nuts (Anacardium occidentale), macadamia nuts (Macadamia integrifolia)), berries (blueberries (Vaccinium corymbosum), cranberries (Vaccinium macrocarpon), blackberries (Rubus fruiticosus), raspberries (Rubus idaeus)), grapes (Vitis labrusca), persimmons (Diospyros kaki Thunberg), olives (Olea europaea), loquats (Eriobotrya japonica), bananas (Ensete ventricosum), coffee (Coffea arabica), nutmeg (Phoenix dactylifera), coconut palm (Cocus nucifera) and oil palm (Elaeis oleifera);

Non-fruit trees: tea (Camellia sinensis), mulberry (Morus alba), trees and shrubs (Satsuki azalea (Rhododenron indicum), camellia (Camellia japonica), hydrangea (Hydrangea macrophylla), sasanqua (Camellia sasanqua), Japanese star anise (Illicium anisatum), cherry (Cerasus xyedoensis), tulip tree (Liriodendron tulipifera), crape myrtle (Lagerstroemth indica), fragrant olive (Osmanthus fragrans var. aurantiacus)), roadside trees (ash (Fraxinus japonica), betula (Betula platyphylla var. japonica), dogwood (Benthamidia eucalyptus (Eucalyptus globulus), ginkgo (Gingko biloba), lilac (Syringa vulgaris), maple (Acer palmatum), oak (Quercus myrsinaefolia), poplar (Populus angulata), Chinese redbud (Cercis chinensis), sweet gum (Liquidambar formosana), sycamore (Platanus orientalis), Japanese zelkova (Zelkova serrata), Japanese arborvitae (Thuja standishii), fir (Abies firma), Japanese hemlock (Tsuga sieboldii), juniper (Juniperus rigida), pine (Pinus densillora), spruce (Picea jezoensis var. hondoensis), Japanese yew (Taxus cuspidata), elm (Ulmus davidiana var. japonica), Japanese horse chestnut (Aesculus turbinata)), sweet viburnum (Viburnum odoratissimum var. awabuki), yew plum pine (Podocarpus macrophyllus), cedar (Cryptomeria japonica), cypress (Chamaecyparis obtuse spp.), croton (Codiaeum variegatum), spindle tree (Euonymus japonicus) and photinia (Photinia glabra);

grasses: turf grasses (Japanese lawn grass (Zoysia japonica), manila grass (Zoysia matrela)), Bermuda grasses (Bermuda grass (Cynodon dactylon)), bent grasses (redtop grass (Agrostis gigantea), creeping bent grass (Agrostis stolonifera), colonial bent grass (Agrostis capillaris)), blue grasses (Kentucky bluegrass (Poa pratensis), montane grass (Poa trivialis)), fescue (fescue grass (Festuca arundinacea), chewing fescue (Festuca rubra L. var. genuina), creeping red fescue (Festuca rubra L. var. commutata)), rye grasses (darnel (Lollum multiflorum), rye grass (Lolium perenne)), orchard grass (Dactylis glomerata) and timothy grass (Phleum pretense);

other: flowering plants (rose (Rosa spp.), carnation (Dianthus caryophyllus), chrysanthemum (Chrysanthemum morifolium chrysanthemum), prairie gentian (Eustoma russellianum), common gypsophila (Gypsophila app.), gerbera (Gerbera Hybrids), marigold (Tagetes spp.), salvia (Salvia spp.), petunia (Petunia xhybrida), verbena (Verbena spp.), tulip (Tulipa gesneriana), aster (Callistephus chinensis), gentian (Gentiana scabra var. buergeri), lily (Lilium app.), pansy (Viola X wittrockiana), cyclamen (Cyclamen spp.), orchid (Orchidaceae spp.), lily of the valley (Convallaria majalis), lavender (Lavender lavandula), stock (Matthiola incana), kale (Brassica oleracea var. acephala f. tricolor), primula (Primula spp. alt.), poinsettia (Euphorbia pulcherrima), gladiola (Gladiolus spp.), cattleya (Cattleya spp.), daisy (Bellis perennis), cymbidium (Cymbidium spp.), begonia (Begonia partita)), biofuel plants (Jatropha (Jatropha curcas), safflower (Carthamus tinctorius), camelinas (Camelina sativa), switch grass (Panicum virgatum), miscanthus (Miscanthus sinensis), canary grass (Phalaris arundinacea), Indian grass (Arundo donax), hemp (Hibiscus cannabinus), cassava (Manihot esculenta), willow (Salicaceae spp.)) and foliage plants.

Preferable examples of the above-mentioned plants include eggplant, tomato, green pepper, red pepper, cucumber, squash, zucchini, watermelon, muskmelon, Japanese white radish, turnip, Chinese cabbage, cabbage, mustard, broccoli, cauliflower, colza, burdock, garland chrysanthemum, artichoke, lettuce, green onion, onion, garlic, asparagus, carrot, parsley, celery, spinach, perilla, mint, basil, strawberry, sweet potato, Japanese yam and taro.

The above-mentioned “plants” may be plants to which resistance has been imparted by breeding methods using gene recombination technology or hybridization.

The composition of the present invention is used to control noxious arthropods of plants by applying to plants or plant growing areas. Here, examples of plants include plant stems and leaves, plant flowers, plant fruits, plant seeds and plant bulbs. Furthermore, here, a plant bulb refers to a discoid stem, bulbous stem, rhizome, tuber, tuberous root and rhizophore.

Examples of noxious arthropods against which the composition containing a noxious arthropod attractant according to the present invention shows control methods include those indicated below:

noxious arthropods of the superorder Exopterygota, order Hemiptera: Delphacidae such as Laodelphax striatellus, Nilaparvata lugens or Sogatella furcifera, Deltcephalidae such as Nephotettix cincticeps or Nephotettix vierscens, Aphididae such as Aphis gossypii, Myzus persicae, Brevicoryne brassicae, Macrosiphum euphorbiae, Aulacorthum solani, Rhopalosiphum padi or Toxoptera citricidus, Pentatomidae such as Nezara antennata, Riptortus clavetus, Leptocorisa chinensis, Eysarcoris parvus, Halyomorpha mista or Lyus lineolaris, Aleyrodidae such as Trialeurodes vaporariorum, Bemisia tabaci or Bemisia argentifolii, Coccidae such as Aonidiella aurantii, Comstockaspis perniciosa, Unaspis citri, Ceroplastes rubens or Icerya purchasi), Tingitidae and Psyllidae;

noxious arthropods of the superorder Exopterygota, order Thysanoptera: Thysanoptera such as Frankliniella occidentals, Thrips palmi, Scirtothrips dorsalis, Thrips tabaci, Frankliniella intonsa or Frankliniella fusca;

noxious arthopods of the superorder Exopterygota, order Lepidoptera: Pyralidae such as Chilo suppressalis, Tryporyza incertulas, Cnaphalocrocis medinalis, Notarcha derogata, Plodia interpunctella, Ostrinia furnacalis, Ostrinia nubilaris, Hellula undalis or Pediasia teterrellus, Noctuidae such as Spodoptera litura, Spodoptera exigua, Pseudaletia separata, Mamestra brassicae, Agrotis ipsilon, Plusia nigrisigna, Trichoplusia spp., Heliothis spp. or Helicoverpa spp., Pieridae such as Pieris rapae, Tortricidae such as Adoxophyes spp., Grapholita molesta, Leguminivora glycinivorella, Matsumuraeses azukivora, Adoxophyes orana fasciata, Adoxophyes sp., Homona magnanima, Archips fuscocupreanus or Cydia pomonella, Gracillariidae such as Caloptilia theivora or Phyllonorycter ringoneella, Carposinidae such as Carposina niponensis, Lyonetiidae such as Rionetia spp., Lymantriidae such as Lymantria spp. or Euproctis spp., Immoidea such as Plutella xylosypiella, Gelechiidae such as Pectinophora gossypiella or Phthorimaea operculella, Arctiidae such as Hyphantria cunea and Tineidae such as Tinea translucens;

noxious arthropods of the superorder Endopterygota, order Diptera: Agromyzidae such as Hylemya antiqua, Hylema platura, Agromyza oryzae, Hydrellia griseola, Chlorops oryzae or Liriomyza trifolii, Dacus cucurbitae and Ceratitis capitata;

noxious arthropods of the superorder Endopterygota, order Coleoptera: Epilacna vigintioctopunctata, Aulacophora femoralis, Phyllotreta striolata, Oulema oryzae, Echinocenemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata and Agriotes spp.;

noxious arthropods of the superorder Endopterygota, order Hymenoptera: Athalia rosae, Acromyrmex spp. and Solenopsis spp.;

noxious arthropods of the superorder Polyneoptera, order Orthoptera: Gryllotalpa Africana, Oxya yezoensis and Oxya japonica;

noxious arthropods of the order Acarina: Tetranychidae such as Tetranychus urticae or Panonychus citri, Eriophyidae such as Aculops pelekassi, Tarsonemidae such as Polyphagotarsoanemus latus, Tenuipalpidae, Tuckerellidae, Accipitridae such as Tyrophagus putrescentiae, Epidermoptidae such as Dermatophagoides farinae or Dermatophagoides ptrenyssnus, and Cheyletidae such as Cheyletus eruditus, Cheyletus malccensis or Cheyletus moorei; and

nematodes: Aphelenchoides besseyi and Nothotylenchus acres.

Examples of noxious arthopods against which the composition containing a noxious arthropod attractant according to the present invention shows control methods particularly include noxious arthropods of the superorder Exopterygota, order Thysanoptera.

### EXAMPLES

Although the following provides a more detailed explanation of the present invention together with test examples indicating the effects and so forth thereof, they are not intended to limit the technical scope of the present invention.

### Test Example 1

Hexane solutions were prepared respectively containing single compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. Each single compound was prepared at five concentration levels consisting of 0.01 μg, 0.1 μg, 1 μg, 10 μg and 100 μg. After impregnating pieces of filter paper with these solutions, the filter paper was affixed on a plastic vial cap using adhesive tape and set up in a water trap containing a surfactant. After releasing 30 adult female Frankliniella occidentalis into an acrylic cage, the water trap containing the above-mentioned attractants was set up in the cage. 24 hours later, the number of Frankliniella occidentalis captured in the water trap was counted and the attraction rate was calculated using Equation 1. The results are shown in TABLE 1.

Attraction rate=(No. of captured individuals in treatment−no. of captured individuals in untreatment)*100/(total no. released per cage) (1)

TABLE 1

| Compound | Amount | | Attraction Rate |
|---|---|---|---|
| p-anisaldehyde | 100 | μg | 36 |
| p-anisaldehyde | 10 | μg | 30 |
| p-anisaldehyde | 1 | μg | 23 |
| p-anisaldehyde | 0.1 | μg | 23 |
| p-anisaldehyde | 0.01 | μg | 17 |
| Benzaldehyde | 100 | μg | 27 |
| Benzaldehyde | 10 | μg | 30 |
| Benzaldehyde | 1 | μg | 36 |
| Benzaldehyde | 0.1 | μg | 33 |
| Benzaldehyde | 0.01 | μg | 23 |
| Ethyl nicotinate | 100 | μg | 43 |
| Ethyl nicotinate | 10 | μg | 36 |
| Ethyl nicotinate | 1 | μg | 30 |
| Ethyl nicotinate | 0.1 | μg | 27 |
| Ethyl nicotinate | 0.01 | μg | 13 |
| Geraniol | 100 | μg | 27 |
| Geraniol | 10 | μg | 33 |
| Geraniol | 1 | μg | 30 |
| Geraniol | 0.1 | μg | 17 |
| Geraniol | 0.01 | μg | 10 |
| Nerol | 100 | μg | 27 |
| Nerol | 10 | μg | 30 |
| Nerol | 1 | μg | 33 |
| Nerol | 0.1 | μg | 33 |
| Nerol | 0.01 | μg | 10 |
| Citronellol | 100 | μg | 23 |
| Citronellol | 10 | μg | 20 |
| Citronellol | 1 | μg | 20 |
| Citronellol | 0.1 | μg | 20 |
| Citronellol | 0.01 | μg | 7 |
| Linalool | 100 | μg | 7 |
| Linalool | 10 | μg | 13 |
| Linalool | 1 | μg | 20 |
| Linalool | 0.1 | μg | 13 |
| Linalool | 0.01 | μg | 13 |
| Methyl anthranilate | 100 | μg | 20 |
| Methyl anthranilate | 10 | μg | 17 |
| Methyl anthranilate | 1 | μg | 13 |
| Methyl anthranilate | 0.1 | μg | 13 |
| Methyl anthranilate | 0.01 | μg | 10 |
| Methyl benzoate | 100 | μg | 36 |
| Methyl benzoate | 10 | μg | 33 |
| Methyl benzoate | 1 | μg | 27 |
| Methyl benzoate | 0.1 | μg | 23 |
| Methyl benzoate | 0.01 | μg | 7 |
| o-aminoacetophenone | 100 | μg | 36 |
| o-aminoacetophenone | 10 | μg | 30 |
| o-aminoacetophenone | 1 | μg | 23 |
| o-aminoacetophenone | 0.1 | μg | 17 |
| o-aminoacetophenone | 0.01 | μg | 3 |
| o-anisidine | 100 | μg | 40 |
| o-anisidine | 10 | μg | 30 |
| o-anisidine | 1 | μg | 20 |
| o-anisidine | 0.1 | μg | 10 |
| o-anisidine | 0.01 | μg | 6 |
| Methyl o-toluate | 100 | μg | 23 |
| Methyl o-toluate | 10 | μg | 20 |
| Methyl o-toluate | 1 | μg | 17 |
| Methyl o-toluate | 0.1 | μg | 13 |
| Methyl o-toluate | 0.01 | μg | 3 |
| Methyl m-aminobenzoate | 100 | μg | 40 |
| Methyl m-aminobenzoate | 10 | μg | 33 |
| Methyl m-aminobenzoate | 1 | μg | 27 |
| Methyl m-aminobenzoate | 0.1 | μg | 10 |
| Methyl m-aminobenzoate | 0.01 | μg | 3 |
| α-hexylcinnamaldehyde | 100 | μg | 30 |
| α-hexylcinnamaldehyde | 10 | μg | 30 |
| α-hexylcinnamaldehyde | 1 | μg | 33 |
| α-hexylcinnamaldehyde | 0.1 | μg | 27 |
| α-hexylcinnamaldehyde | 0.01 | μg | 13 |

| | | |
|---|---|---|
| Control (hexane) | — | 3 |

### Test Example 2

Mixed hexane solutions were prepared respectively containing two types of compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. The weight of each compound was adjusted to the weight that showed the highest attraction rate based on Test Example 1. After impregnating pieces of filter paper with the mixed solution of the two types of compounds, the filter paper was affixed on a plastic vial cap using adhesive tape and set up in a water trap containing a surfactant. After releasing 30 adult female Frankliniella occidentalis into an acrylic cage, the water trap containing the above-mentioned mixed attractants was set up in the cage. 24 hours later, the number of Frankliniella occidentalis captured in the water trap was counted and the attraction rate was calculated using Equation 1. In addition, hexane solutions were also prepared containing each of the single compounds at their respective prescribed concentrations for the sake of comparison, and those solutions were tested in the same manner. The results are shown in TABLE 2.

Attraction rate=(No. of captured individuals in treatment−no. of captured individuals in untreatment)*100/(total no. released per cage) (1)

In general, a synergistic attracting effect expected when mixing two given types of attractive compounds and using for treatment is determined from Colby's equation indicated with the following Equation 2:

E=X+Y−(X*Y)/100 (2)

wherein,

X: attraction rate when treated with attractive compound A;

Y: attraction rate when treated with attractive compound B; and

E: attraction rate expected when treating by mixing attractive compound A and attractive compound B (expected attraction rate value).

TABLE 2

| | | | Expected |
|---|---|---|---|
| | | Attrac- | Attraction |
| Combination | | tion | Rate |
| (Amt. of Compounds) | | Rate | Value |
| Benzaldehyde | o-anisidine | 83 | 58 |
| (1 μg) | (100 μg) | | |
| Benzaldehyde | o-aminoacetophenone | 79 | 56 |
| (1 μg) | (100 μg) | | |
| Benzaldehyde | Methyl benzoate | 69 | 57 |
| (1 μg) | (100 μg) | | |
| o-anisidine | o-aminoacetophenone | 63 | 58 |
| (100 μg) | (100 μg) | | |
| o-anisidine | p-anisaldehyde | 66 | 62 |
| (100 μg) | (100 μg) | | |
| p-anisaldehyde | Ethyl nicotinate | 66 | 60 |
| (100 μg) | (100 μg) | | |
| p-anisaldehyde | Methyl m-aminobenzoate | 62 | 58 |
| (100 μg) | (100 μg) | | |
| p-anisaldehyde | Methyl benzoate | 69 | 55 |
| (100 μg) | (100 μg) | | |
| p-anisaldehyde | o-aminoacetophenone | 57 | 55 |
| (100 μg) | (100 μg) | | |
| p-anisaldehyde | α-hexylcinnamaldehyde | 61 | 53 |
| (100 μg) | (1 μg) | | |
| p-anisaldehyde | Geraniol | 58 | 53 |
| (100 μg) | (10 μg) | | |
| p-anisaldehyde | Nerol | 58 | 53 |
| (100 μg) | (1 μg) | | |
| p-anisaldehyde | Citronellol | 50 | 46 |
| (100 μg) | (100 μg) | | |
| p-anisaldehyde | Linalool | 50 | 44 |
| (100 μg) | (1 μg) | | |
| p-anisaldehyde | Methyl o-toluate | 51 | 46 |
| (100 μg) | (100 μg) | | |
| p-anisaldehyde | Methyl anthranilate | 53 | 44 |
| (100 μg) | (100 μg) | | |
| Ethyl nicotinate | Methyl m-aminobenzoate | 66 | 62 |
| (100 μg) | (100 μg) | | |
| Ethyl nicotinate | Methyl benzoate | 73 | 60 |
| (100 μg) | (100 μg) | | |
| Ethyl nicotinate | o-aminoacetophenone | 63 | 60 |
| (100 μg) | (100 μg) | | |
| Ethyl nicotinate | α-hexylcinnamaldehyde | 61 | 58 |
| (100 μg) | (1 μg) | | |
| Ethyl nicotinate | Geraniol | 62 | 58 |
| (100 μg) | (10 μg) | | |
| Ethyl nicotinate | Nerol | 62 | 58 |
| (100 μg) | (1 μg) | | |
| Ethyl nicotinate | Citronellol | 55 | 52 |
| (100 μg) | (100 μg) | | |
| Ethyl nicotinate | Linalool | 51 | 50 |
| (100 μg) | (1 μg) | | |
| Ethyl nicotinate | Methyl o-toluate | 54 | 52 |
| (100 μg) | (100 μg) | | |
| Ethyl nicotinate | Methyl anthranilate | 52 | 50 |
| (100 μg) | (100 μg) | | |
| Methyl m-aminobenzoate | Geraniol | 59 | 56 |
| (100 μg) | (10 μg) | | |
| Methyl m-aminobenzoate | Nerol | 58 | 56 |
| (100 μg) | (1 μg) | | |
| Methyl m-aminobenzoate | Citronellol | 52 | 50 |
| (100 μg) | (100 μg) | | |
| Methyl m-aminobenzoate | Linalool | 51 | 48 |
| (100 μg) | (1 μg) | | |
| Methyl m-aminobenzoate | Methyl anthranilate | 52 | 48 |
| (100 μg) | (100 μg) | | |
| Methyl benzoate | α-hexylcinnamaldehyde | 58 | 53 |
| (100 μg) | (1 μg) | | |
| Methyl benzoate | Geraniol | 55 | 53 |
| (100 μg) | (10 μg) | | |
| Methyl benzoate | Nerol | 55 | 53 |
| (100 μg) | (1 μg) | | |
| Methyl benzoate | Citronellol | 50 | 46 |
| (100 μg) | (100 μg) | | |
| Methyl benzoate | Linalool | 47 | 44 |
| (100 μg) | (1 μg) | | |
| Methyl benzoate | Methyl anthranilate | 46 | 44 |
| (100 μg) | (100 μg) | | |
| Geraniol | Methyl anthranilate | 43 | 42 |
| (10 μg) | (100 μg) | | |
| Nerol | Methyl anthranilate | 48 | 42 |
| (1 μg) | (100 μg) | | |
| Citronellol | Methyl anthranilate | 37 | 34 |
| (100 μg) | (100 μg) | | |
| Linalool | Methyl anthranilate | 35 | 31 |
| (1 μg) | (100 μg) | | |
| Ethyl nicotinate | — | 43 | — |
| (100 μg) | | | |
| o-anisidine | — | 40 | — |
| (100 μg) | | | |
| Methyl m-aminobenzoate | — | 40 | — |
| (100 μg) | | | |
| p-anisaldehyde | — | 36 | — |
| (100 μg) | | | |
| Benzaldehyde | — | 36 | — |
| (1 μg) | | | |
| o-aminoacetophenone | — | 36 | — |
| (100 μg) | | | |
| Methyl benzoate | — | 36 | — |
| (100 μg) | | | |
| α-hexylcinnamaldehyde | — | 33 | — |
| (1 μg) | | | |
| Geraniol | — | 33 | — |
| (10 μg) | | | |
| Nerol | — | 33 | — |
| (1 μg) | | | |
| Citronellol | — | 23 | — |
| (100 μg) | | | |
| Methyl o-toluate | — | 23 | — |
| (100 μg) | | | |
| Methyl anthranilate | — | 20 | — |
| (100 μg) | | | |
| Linalool | — | 20 | — |
| (1 μg) | | | |
| Control | — | 3 | — |
| (hexane) | | | |

### Test Example 3

Mixed hexane solutions were prepared containing three types of compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. The weight of each compound was adjusted to the weight that showed the highest attraction rate based on Test Example 1. After impregnating pieces of filter paper with the mixed solution of the three types of compounds, the filter paper was affixed on a plastic vial cap using adhesive tape and set up in a pan trap containing a surfactant. After releasing 30 adult female Frankliniella occidentalis into an acrylic cage, the water trap containing the above-mentioned mixed attractants was set up in the cage. 24 hours later, the number of Frankliniella occidentalis captured in the water trap was counted and the attraction rate was calculated using Equation 1. In addition, hexane solutions were also prepared containing each of the single agents at their respective prescribed concentrations for the sake of comparison, and those solutions were tested in the same manner. The results are shown in TABLE 3.

In general, a synergistic attracting effect expected when mixing three given types of attractive compounds and using for treatment is determined from Colby's equation indicated with the following Equation 3:

E=X+Y+Z−(X*Y+X*Z+Y*Z)/100+X*Y*Z/10000 (3)

wherein,

X: attraction rate when treated with attractive compound A;

Y: attraction rate when treated with attractive compound B;

Z: attraction rate when treated with attractive compound C; and

E: attraction rate expected when treating by mixing attractive compound A, attractive compound B and attractive compound C (expected attraction rate value).

TABLE 3

| | | | | Expected |
|---|---|---|---|---|
| Combination | | | Attraction | Attraction |
| (Amt. of Compounds) | | | Rate | Rate Value |
| p-anisaldehyde | Ethyl nicotinate | Methyl | 77 | 75 |
| (100 μg) | (100 μg) | m-aminobenzoate | | |
| | | (100 μg) | | |
| p-anisaldehyde | Ethyl nicotinate | Methyl benzoate | 79 | 73 |
| (100 μg) | (100 μg) | (100 μg) | | |
| p-anisaldehyde | Ethyl nicotinate | o-aminoacetophenone | 78 | 73 |
| (100 μg) | (100 μg) | (100 μg) | | |
| p-anisaldehyde | Ethyl nicotinate | α-hexylcinnamaldehyde | 78 | 72 |
| (100 μg) | (100 μg) | (1 μg) | | |
| p-anisaldehyde | Ethyl nicotinate | Geraniol | 79 | 72 |
| (100 μg) | (100 μg) | (10 μg) | | |
| p-anisaldehyde | Ethyl nicotinate | Nerol | 74 | 72 |
| (100 μg) | (100 μg) | (1 μg) | | |
| p-anisaldehyde | Ethyl nicotinate | Citronellol | 72 | 68 |
| (100 μg) | (100 μg) | (100 μg) | | |
| p-anisaldehyde | Ethyl nicotinate | Linalool | 73 | 67 |
| (100 μg) | (100 μg) | (1 μg) | | |
| p-anisaldehyde | Ethyl nicotinate | Methyl o-toluate | 73 | 68 |
| (100 μg) | (100 μg) | (100 μg) | | |
| p-anisaldehyde | Ethyl nicotinate | Methyl | 74 | 67 |
| (100 μg) | (100 μg) | anthranilate | | |
| | | (100 μg) | | |
| p-anisaldehyde | Methyl benzoate | Methyl | 75 | 72 |
| (100 μg) | (100 μg) | m-aminobenzoate | | |
| | | (100 μg) | | |
| p-anisaldehyde | Methyl benzoate | o-aminoacetophenone | 77 | 70 |
| (100 μg) | (100 μg) | (100 μg) | | |
| p-anisaldehyde | Methyl benzoate | α-hexylcinnamaldehyde | 78 | 70 |
| (100 μg) | (100 μg) | (1 μg) | | |
| p-anisaldehyde | Methyl benzoate | Geraniol | 71 | 69 |
| (100 μg) | (100 μg) | (10 μg) | | |
| p-anisaldehyde | Methyl benzoate | Nerol | 72 | 69 |
| (100 μg) | (100 μg) | (1 μg) | | |
| p-anisaldehyde | Methyl benzoate | Citronellol | 72 | 69 |
| (100 μg) | (100 μg) | (100 μg) | | |
| p-anisaldehyde | Methyl benzoate | Linalool | 71 | 64 |
| (100 μg) | (100 μg) | (1 μg) | | |
| p-anisaldehyde | Methyl benzoate | Methyl o-toluate | 70 | 63 |
| (100 μg) | (100 μg) | (100 μg) | | |
| p-anisaldehyde | Methyl benzoate | Methyl | 67 | 64 |
| (100 μg) | (100 μg) | anthranilate | | |
| | | (100 μg) | | |
| p-anisaldehyde | Methyl benzoate | Benzaldehyde | 75 | 70 |
| (100 μg) | (100 μg) | (1 μg) | | |
| p-anisaldehyde | Methyl | Methyl | 67 | 65 |
| (100 μg) | anthranilate | m-aminobenzoate | | |
| | (100 μg) | (100 μg) | | |
| p-anisaldehyde | Methyl | Methyl benzoate | 65 | 63 |
| (100 μg) | anthranilate | (100 μg) | | |
| | (100 μg) | | | |
| p-anisaldehyde | Methyl | o-aminoacetophenone | 64 | 61 |
| (100 μg) | anthranilate | (100 μg) | | |
| | (100 μg) | | | |
| p-anisaldehyde | Methyl | α-hexylcinnamaldehyde | 64 | 61 |
| (100 μg) | anthranilate | (1 μg) | | |
| | (100 μg) | | | |
| p-anisaldehyde | Methyl | Geraniol | 63 | 61 |
| (100 μg) | anthranilate | (10 μg) | | |
| | (100 μg) | | | |
| p-anisaldehyde | Methyl | Nerol | 66 | 61 |
| (100 μg) | anthranilate | (1 μg) | | |
| | (100 μg) | | | |
| p-anisaldehyde | Methyl | Citronellol | 58 | 56 |
| (100 μg) | anthranilate | (100 μg) | | |
| | (100 μg) | | | |
| p-anisaldehyde | Methyl | Linalool | 58 | 54 |
| (100 μg) | anthranilate | (1 μg) | | |
| | (100 μg) | | | |
| Ethyl nicotinate | Methyl benzoate | Geraniol | 73 | 72 |
| (100 μg) | (100 μg) | (10 μg) | | |
| Ethyl nicotinate | Methyl benzoate | Nerol | 81 | 72 |
| (100 μg) | (100 μg) | (1 μg) | | |
| Ethyl nicotinate | Methyl benzoate | Citronellol | 71 | 68 |
| (100 μg) | (100 μg) | (100 μg) | | |
| Ethyl nicotinate | Methyl benzoate | Linalool | 70 | 67 |
| (100 μg) | (100 μg) | (1 μg) | | |
| Ethyl nicotinate | Methyl | Benzaldehyde | 75 | 73 |
| (100 μg) | anthranilate | (1 μg) | | |
| | (100 μg) | | | |
| Ethyl nicotinate | Methyl | Methyl | 72 | 69 |
| (100 μg) | anthranilate | m-aminobenzoate | | |
| | (100 μg) | (100 μg) | | |
| Ethyl nicotinate | Methyl | Methyl benzoate | 71 | 67 |
| (100 μg) | anthranilate | (100 μg) | | |
| | (100 μg) | | | |
| Ethyl nicotinate | Methyl | Geraniol | 72 | 65 |
| (100 μg) | anthranilate | (10 μg) | | |
| | (100 μg) | | | |
| Ethyl nicotinate | Methyl | Nerol | 71 | 65 |
| (100 μg) | anthranilate | (1 μg) | | |
| | (100 μg) | | | |
| Ethyl nicotinate | Methyl | Citronellol | 63 | 60 |
| (100 μg) | anthranilate | (100 μg) | | |
| | (100 μg) | | | |
| Ethyl nicotinate | Methyl | Linalool | 64 | 59 |
| (100 μg) | anthranilate | (1 μg) | | |
| | (100 μg) | | | |
| Ethyl nicotinate | Methyl | o-anisidine | 65 | 60 |
| (100 μg) | anthranilate | (100 μg) | | |
| | (100 μg) | | | |
| Ethyl nicotinate | — | — | 43 | — |
| (100 μg) | | | | |
| o-anisidine | — | — | 40 | — |
| (100 μg) | | | | |
| Methyl | — | — | 40 | — |
| m-aminobenzoate | | | | |
| (100 μg) | | | | |
| p-anisaldehyde | — | — | 36 | — |
| (100 μg) | | | | |
| Benzaldehyde | — | — | 36 | — |
| (1 μg) | | | | |
| o-aminoacetophenone | — | — | 36 | — |
| (100 μg) | | | | |
| Methyl benzoate | — | — | 46 | — |
| (100 μg) | | | | |
| α-hexylcinnamaldehyde | — | — | 33 | — |
| (1 μg) | | | | |
| Geraniol | — | — | 33 | — |
| (10 μg) | | | | |
| Nerol | — | — | 33 | — |
| (1 μg) | | | | |
| Citronellol | — | — | 23 | — |
| (100 μg) | | | | |
| Methyl o-toluate | — | — | 23 | — |
| (100 μg) | | | | |
| Methyl | — | — | 20 | — |
| anthranilate | | | | |
| (100 μg) | | | | |
| Linalool | — | — | 20 | — |
| (1 μg) | | | | |
| Control | — | — | 3 | — |
| (hexane) | | | | |

### Test Example 4

Mixed hexane solutions were prepared respectively containing two types of compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. The weight of each compound was adjusted to 1 μg. After impregnating pieces of filter paper (3 mm²) with the mixed solution of the two types of compounds, the filter paper was set up at the head of a plastic tube (length of 9 cm, 5 mm² in diameters). An adult Tetranychus urticae was released into the end of plastic tube. Among 10 minutes, the number of T. urticae contacted the filter paper was counted and the attraction rate was calculated using Equation 1. In addition, hexane solutions were also prepared containing each of the single compounds at their respective prescribed concentrations for the sake of comparison, and those solutions were tested in the same manner. The results are shown in TABLE 4.

Attraction rate=(No. of contacted individuals in treatment−no. of contacted individuals in untreatment)*100/(repetition) (1)

In general, a synergistic attracting effect expected when mixing two given types of attractive compounds and using for treatment is determined from Colby's equation indicated with the following Equation 2:

E=X+Y−(X*Y)/100 (2)

wherein,

X: attraction rate when treated with attractive compound A;

Y: attraction rate when treated with attractive compound B;

and

E: attraction rate expected when treating by mixing attractive compound A and attractive compound B (expected attraction rate value).

[Table 4]

TABLE 4

| | | | Expected |
|---|---|---|---|
| | | Attraction | Attraction |
| Combination | | Rate | Rate Value |
| Benzaldehyde | o-anisidine | 75 | 42 |
| Benzaldehyde | o-aminoacetophenone | 65 | 58 |
| Ethyl nicotinate | Methyl o-toluate | 35 | 11 |
| Methyl benzoate | Linalool | 35 | 29 |
| Linalool | Nerol | 18 | 10 |
| Benzaldehyde | — | 32 | — |
| o-anisidine | — | 15 | — |
| o-aminoacetophenone | — | 38 | — |
| Ethyl nicotinate | — | 15 | — |
| Methyl o-toluate | — | 15 | — |
| Methyl benzoate | — | 25 | — |
| Linalool | — | 5 | — |
| Nerol | — | 5 | — |
| Control (hexane) | — | 15 | — |

### Test Example 5

Mixed hexane solutions were prepared respectively containing two types of compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. The weight of each compound was adjusted to 100 μg. After impregnating pieces of filter paper with the mixed solution of the two types of compounds, the filter paper was affixed on a plastic vial cap using adhesive tape and set up in a water trap containing a surfactant. After releasing 20 adult Drosophila melanogaster into an acrylic cage, the water trap containing the above-mentioned mixed attractants was set up in the cage. 24 hours later, the number of D. melanogaster captured in the water trap was counted and the attraction rate was calculated using Equation 1. In addition, hexane solutions were also prepared containing each of the single compounds at their respective prescribed concentrations for the sake of comparison, and those solutions were tested in the same manner. The results are shown in TABLE 5.

Attraction rate=(No. of captured individuals in treatment−no. of captured individuals in untreatment)*100/(total no. released per cage) (1)

In general, a synergistic attracting effect expected when mixing two given types of attractive compounds and using for treatment is determined from Colby's equation indicated with the following Equation 2:

E=X+Y−(X*Y)/100 (2)

wherein,

X: attraction rate when treated with attractive compound A;

Y: attraction rate when treated with attractive compound B; and

E: attraction rate expected when treating by mixing attractive compound A and attractive compound B (expected attraction rate value).

TABLE 5

| | | | Expected |
|---|---|---|---|
| | | | Attraction |
| | | Attraction | Rate |
| Combination | | Rate | Value |
| Benzaldehyde | o-anisidine | 28 | 10 |
| Benzaldehyde | o-aminoacetophenone | 43 | 15 |
| Benzaldehyde | Methyl benzoate | 33 | 10 |
| o-anisidine | p-anisaldehyde | 18 | 10 |
| p-anisaldehyde | Methyl benzoate | 13 | 10 |
| p-anisaldehyde | Geraniol | 28 | 24 |
| p-anisaldehyde | Nerol | 18 | 5 |
| Ethyl nicotinate | Methyl | 78 | 10 |
| | m-aminobenzoate | | |
| Ethyl nicotinate | Methyl benzoate | 33 | 10 |
| Ethyl nicotinate | o-aminoacetophenone | 23 | 15 |
| Ethyl nicotinate | α- | 13 | 10 |
| | hexylcinnamaldehyde | | |
| Ethyl nicotinate | Nerol | 8 | 5 |
| Ethyl nicotinate | Citronellol | 8 | 5 |
| Ethyl nicotinate | Linalool | 33 | 5 |
| Ethyl nicotinate | Methyl o-toluate | 23 | 5 |
| Ethyl nicotinate | Methyl anthranilate | 33 | 10 |
| Methyl benzoate | α- | 33 | 14 |
| | hexylcinnamaldehyde | | |
| Methyl benzoate | Nerol | 13 | 10 |
| Methyl benzoate | Citronellol | 38 | 10 |
| Methyl benzoate | Linalool | 18 | 10 |
| Methyl benzoate | Methyl anthranilate | 18 | 14 |
| Citronellol | Methyl anthranilate | 13 | 10 |
| Linalool | Methyl anthranilate | 18 | 10 |
| Methyl m-aminobenzoate | Citronellol | 23 | 10 |
| Methyl m-aminobenzoate | Linalool | 33 | 10 |
| Methyl m-aminobenzoate | Methyl anthranilate | 18 | 14 |
| p-anisaldehyde | — | 3 | — |
| Benzaldehyde | — | 3 | — |
| Ethyl nicotinate | — | 3 | — |
| Methyl anthranilate | — | 8 | — |
| Methyl benzoate | — | 8 | — |
| o-aminoacetophenone | — | 13 | — |
| o-anisidine | — | 8 | — |
| Methyl m-aminobenzoate | — | 8 | — |
| Methyl o-toluate | — | 3 | — |
| α-hexylcinnamaldehyde | — | 8 | — |
| Linalool | — | 3 | — |
| Nerol | — | 3 | — |
| Geraniol | — | 23 | — |
| Citronellol | — | 3 | — |
| Control (hexane) | — | 3 | — |

### Test Example 6

Mixed hexane solutions were prepared respectively containing two types of compounds selected from among p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde. The weight of each compound was adjusted to 1 μg. After impregnating pieces of filter paper (3 mm²) with the mixed solution of the two types of compounds, the filter paper was affixed on a yellow sticky trap (1 cm²). After releasing 10 adult Thrips tabaci into a plastic cup (150 ml), the yellow sticky trap containing the above-mentioned mixed attractants was set up at the side of the plastic cup. 24 hours later, the number of T. tabaci captured in the yellow sticky trap was counted and the attraction rate was calculated using Equation 1. In addition, hexane solutions were also prepared containing each of the single compounds at their respective prescribed concentrations for the sake of comparison, and those solutions were tested in the same manner. The results are shown in TABLE 6.

Attraction rate=(No. of captured individuals in treatment−no. of captured individuals in untreatment)*100/(total no. released per cup) (1)

In general, a synergistic attracting effect expected when mixing two given types of attractive compounds and using for treatment is determined from Colby's equation indicated with the following Equation 2:

E=X+Y−(X*Y)/100 (2)

wherein,

X: attraction rate when treated with attractive compound A;

Y: attraction rate when treated with attractive compound B;

and

E: attraction rate expected when treating by mixing attractive compound A and attractive compound B (expected attraction rate value).

TABLE 6

| | | | Expected |
|---|---|---|---|
| | | | Attraction |
| | | Attraction | Rate |
| Combination | | Rate | Value |
| o-anisidine | p-anisaldehyde | 40 | 10 |
| p-anisaldehyde | Ethyl nicotinate | 27 | 19 |
| p-anisaldehyde | α- | 30 | 16 |
| | hexylcinnamaldehyde | | |
| p-anisaldehyde | Linalool | 30 | 10 |
| p-anisaldehyde | Methyl anthranilate | 20 | 19 |
| Ethyl nicotinate | Methyl | 20 | 10 |
| | m-aminobenzoate | | |
| Ethyl nicotinate | α- | 30 | 16 |
| | hexylcinnamaldehyde | | |
| α-hexylcinnamaldehyde | Geraniol | 10 | 7 |
| α-hexylcinnamaldehyde | o-anisidine | 10 | 7 |
| α-hexylcinnamaldehyde | Linalool | 40 | 7 |
| p-anisaldehyde | — | 10 | — |
| Ethyl nicotinate | — | 10 | — |
| Methyl anthranilate | — | 10 | — |
| o-anisidine | — | 0 | — |
| Methyl m-aminobenzoate | — | 0 | — |
| α-hexylcinnamaldehyde | — | 7 | — |
| Linalool | — | 0 | — |
| Geraniol | — | 0 | — |
| Control (hexane) | — | 0 | — |

### INDUSTRIAL APPLICABILITY

According to the present invention, a composition for high-active controlling noxious arthropods, and a method capable of effectively monitoring and controlling noxious arthropods, can be provided.

1. A composition for attracting noxious arthropods comprising at least two types of compounds selected from plant-derived kairomones and analogues thereof, wherein the kairomones and analogues thereof are selected from the group consisting of p-anisaldehyde, benzaldehyde, ethyl nicotinate, geraniol, linalool, nerol, citronellol, o-anisaldehyde, β-farnesene, methyl anthranilate, methyl benzoate, o-aminoacetophenone, o-anisidine, methyl m-aminobenzoate, methyl o-toluate, eugenol, 3-phenylpropylaldehyde, cinnamaldehyde, eucalyptol, squalene and α-hexylcinnamaldehyde, and have a synergistic effect on the attractiveness to noxious arthropods.

2. A composition for attracting noxious arthropods comprising at least two types of compounds selected from plant-derived kairomones and analogues thereof, wherein the kairomones and analogues thereof are selected from the group consisting of p-anisaldehyde, benzaldehyde, ethyl nicotinate, geraniol, linalool, nerol, citronellol, methyl anthranilate, methyl benzoate, o-aminoacetophenone, o-anisidine, methyl m-aminobenzoate, methyl o-toluate and α-hexylcinnamaldehyde, and have a synergistic effect on the attractiveness to noxious arthropods.

3. A composition for attracting noxious arthropods comprising at least two types of compounds selected from plant-derived kairomones and analogues thereof, wherein the kairomones and analogues thereof are selected from the group consisting of p-anisaldehyde, benzaldehyde, ethyl nicotinate, methyl anthranilate, methyl benzoate, o-aminoacetophenone, o-anisidine, methyl m-aminobenzoate, methyl o-toluate and α-hexylcinnamaldehyde, and have a synergistic effect on the attractiveness to noxious arthropods.

4. The composition according to claim 1, wherein two types of compounds are selected from the plant-derived kairomones and analogues thereof.

5. The composition according to claim 1, wherein three types of compounds are selected from the plant-derived kairomones and analogues thereof.

6. The composition according to claim 4, wherein the two types of compounds are combined at a ratio of 0.0999 to 99.9001:99.9001 to 0.0999 based on the weight ratio thereof.

7. The composition according to claim 4, wherein the two types of compounds are combined at a ratio of 0.1996 to 99.8004:99.8004 to 0.1996 based on the weight ratio thereof.

8. The composition according to claim 4, wherein the two types of compounds are combined at a ratio of 0.99 to 99.01:99.01 to 0.99 based on the weight ratio thereof.

9. The composition according to claim 5, wherein the three types of compounds are combined at a ratio of 0.0998 to 99.8004:99.8004 to 0.0998:0.0998 to 99.8004 based on the weight ratio thereof.

10. The composition according to claim 5, wherein the three types of compounds are combined at a ratio of 0.1992 to 99.6016:99.6016 to 0.1992:0.1992 to 99.6016 based on the weight ratio thereof.

11. The composition according to claim 5, wherein the three types of compounds are combined at a ratio of 0.98039 to 98.03922:98.03922 to 0.98039:0.98039 to 98.03922 based on the weight ratio thereof.

12. A method for controlling and/or monitoring the noxious arthropods comprising using the composition according to claim 1 against noxious arthropods.

13. The composition according to claim 2, wherein two types of compounds are selected from the plant-derived kairomones and analogues thereof.

14. The composition according to claim 3, wherein two types of compounds are selected from the plant-derived kairomones and analogues thereof.

15. The composition according to claim 2, wherein three types of compounds are selected from the plant-derived kairomones and analogues thereof.

16. The composition according to claim 3, wherein three types of compounds are selected from the plant-derived kairomones and analogues thereof.

17. A method for controlling and/or monitoring the noxious arthropods comprising using the composition according to claim 2 against noxious arthropods.

18. A method for controlling and/or monitoring the noxious arthropods comprising using the composition according to claim 3 against noxious arthropods.
